(19) United States
(12) Patent Application Publication
(10) Pub. No.: US 2011/0191415 A1
(43) Pub. Date: Aug. 4, 2011

(54) COMMUNICATION SETUP

(76) Inventor: Bruce F. Wong, Athens, GA (US)

(21) Appl. No.: 12/699,681

(22) Filed: Feb. 3, 2010

(51) Int. Cl. G06F 15/16

(52) U.S. Cl. 709/204; 709/227

(57) ABSTRACT

A method includes monitoring user desire for a user and contact availability for a contact, wherein user desire indicates whether the user desires to communicate with the contact and contact availability indicates whether the contact is available to communicate with the user; determining whether the user desires to communicate with the contact based on user desire and whether the contact is available to communicate with the user based on contact availability; and performing communication setup when the user desires to communicate with the contact and whether the contact is available to communicate with the user.

### FIELD

The present embodiments relate generally to telecommunication.

### BACKGROUND

When a user wants or needs to communicate with a contact, the user initiates communication, for example, by placing a phone call to the contact or establishing an instant messaging session. Generally, users risk the possibility of failing to reach the contact when initiating communication with the contact, for example, because the contact is not available to receive the communication or because the contact does not desire to communicate with the user.

### BRIEF DESCRIPTION OF THE DRAWINGS

FIG. 1 illustrates one embodiment of a communication system including a user device, contact device, and server;

FIG. 2 illustrates one embodiment of the interaction between the components of the communication system of FIG. 1 based on user desire and contact availability;

FIG. 3 illustrates one embodiment of the interaction between the components of the communication system of FIG. 1 based on user desire, contact availability, user availability, and contact desire;

FIG. 4 illustrates one embodiment of a server operable to perform communication setup;

FIG. 5 illustrates one embodiment of a social network service of a user;

FIG. 6A illustrates one embodiment of a user calendar, and FIG. 6B illustrates one embodiment of a contact calendar;

FIG. 7A illustrates one embodiment of a task list, and FIG. 7B illustrates one embodiment of a matching application;

FIG. 8 illustrates one embodiment of a search engine with search engine results; and

FIG. 9 illustrates one embodiment of a method for performing communication setup.

### DETAILED DESCRIPTION

### Overview

The present embodiments relate generally to communication setup. Communication setup may include setup of one or more communication connections among one or more endpoints. Setup may include directly or indirectly initiating, reserving, requesting, preparing, commanding, establishing, or any combination thereof. Communication connections may be audio connections (e.g., phone call), textual connections (e.g., text message services or instant messaging services), graphical connections (e.g., media message services), video connections (e.g., videoconferencing), or any combination thereof. Examples of communication setup may include establishing a phone call, initiating a chat session, or sending a text message.

In one embodiment, communication setup may be performed based on user desire, contact availability, or both user desire and contact availability. User desire includes, indicates, or represents a user's desire, want, or need to communicate with a contact. Contact availability includes, indicates, or represents the contact's willingness or ability to communicate with the user. Communication setup may be performed manually (e.g., with user and/or contact interaction), automatically (e.g., without user and/or contact interaction), or semi-automatically. For example, in one embodiment, user desire and contact availability is monitored and communication setup is performed when the user desires, wants, or needs to communicate with the contact and the contact is available.

One benefit of performing communication setup based on user desire and contact availability is that a user may not need to manually monitor a contact's availability. In other words, the user does not need to coordinate with the contact, for example, by watching an availability status for the contact or by setting up a conference or checking the contact's calendar, in order to communicate with the contact.

Symmetry between the user and the contact may be equal or weighted. For example, in one embodiment, communication setup may be based on contact desire. Contact desire includes, indicates, or represents a contact's desire, want, or need to communicate with a user. Contact desire may be used in combination with user desire, contact availability, or both user desire and contact availability. Even when the user desires, wants, or needs to communicate with the contact and the contact is available, communication setup may only be performed when the contact desires, wants, or needs to communicate with the user.

In another embodiment, communication setup may be based on user availability. User availability indicates the user's willingness or ability to communicate with the contact. User availability may be used in combination with user desire, contact availability, contact desire, or any combination thereof. For example, in one embodiment, communication setup may be performed when both the user and contact desire, want, or need to communicate with each other and both the user and contact are available.

User availability, user desire, contact availability, contact desire, or any combination thereof may be used to intelligently match a user with a contact. Matching may include performing or allowing communication setup between one or more communication devices related, associated, owned, or otherwise controlled by the user and one or more communication devices related, associated, owned, or otherwise controlled by the contact. As a result of performing or allowing communication setup, the user and the contact may communicate.

### DESCRIPTION OF PRESENT EMBODIMENTS

The present embodiments relate generally to communication setup. For example, in one embodiment, a communication system includes a user device, a contact device, and a server. The server is operable to monitor user desire and contact availability. Communication may be automatically setup between the user device and contact device when the user desires, wants, or needs to communicate with the contact and the contact is available.

The present embodiments include various aspects of systems and methods that relate generally to communication setup.

In one aspect, a method includes monitoring user desire for a user and contact availability for a contact, wherein user desire indicates whether the user desires to communicate with the contact and contact availability indicates whether the contact is available to communicate with the user; determining whether the user desires to communicate with the contact based on user desire and whether the contact is available to communicate with the user based on contact availability; and performing communication setup when the user desires to communicate with the contact and whether the contact is available to communicate with the user.

In another aspect, a networking device includes a processor operable to monitor user desire for a user and contact availability for a contact, wherein user desire indicates whether the user desires to communicate with the contact and contact availability indicates whether the contact is available to communicate with the user; determine whether the user desires to communicate with the contact based on user desire and whether the contact is available to communicate with the user based on contact availability; and perform communication setup when the user desires to communicate with the contact and whether the contact is available to communicate with the user.

In yet another aspect, a method includes receiving, using a processor, an indication that a user wants, needs, or desires to communicate with a contact; receiving an availability of the contact; and performing, using the processor, communication setup between a user device and a contact device when the contact is selected and is available.

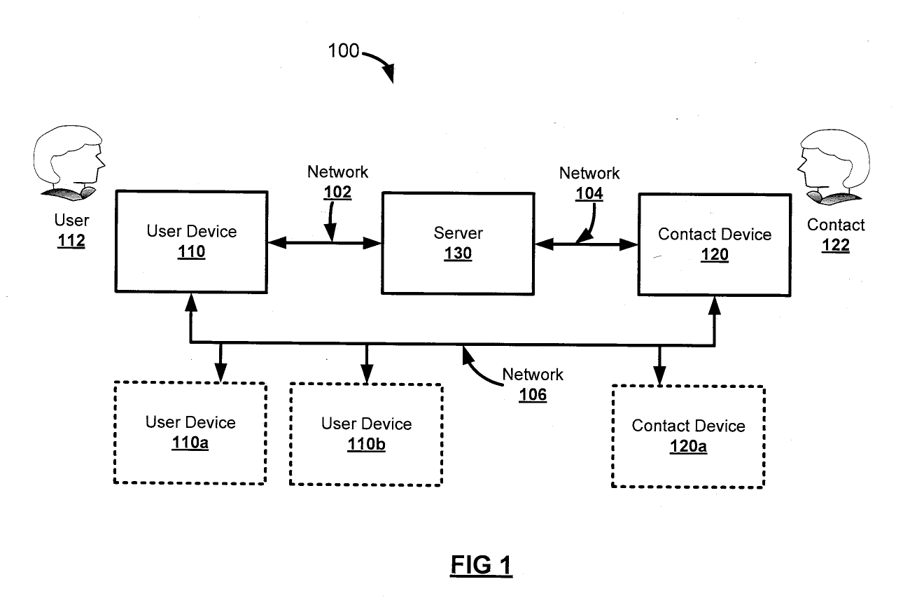

FIG. 1 illustrates one embodiment of a communication system 100. The system 100 includes a user device 110, a contact device 120, and a server 130. Additional, different, or fewer components may be provided. The server 130 may be coupled with the user device 110 via the network 102 and the contact device 120 via the network 104. The user device 110 may be coupled with the contact device 120 via the network 106. As used herein, the term “coupled with” may include directly or indirectly connected through one or more intermediary components. Intermediary components may include software and/or hardware components. For example, one or more additional servers and/or gateways may be located between the user device 110 and the server 130.

The networks 102, 104, 106 may be telecommunication networks, wireless networks, wired networks, radio networks, Internet networks, Intranet networks, Transmission Control Protocol (TCP)/Internet Protocol (IP) networks, packet-based networks, fiber optic networks, telephone networks, cellular networks, computer networks, public switched telephone networks, or any other now known or later developed networks. Exemplary telecommunication networks may include wide area networks, local area networks, virtual private networks, peer-to-peer networks, and wireless local area networks. Network 102 may be the same or different than network 104. Networks 102 and/or 104 may be the same or different than network 106. In one embodiment, network 102 is a telephone (PSTN) network and network 104 is a packet-based network, such as an Ethernet network. The networks 102, 104, 106 may be operable to transmit messages, communication, information, or other data.

The user device 110 may be owned, operated, controlled, managed, or otherwise used by a user 112. The user 112 may be a human or electronic computing device (e.g., including a processor and/or memory) configured to control the user device 110. The user device 110 may be a public switched telephone, cellular telephone, personal computer, personal digital assistant, mobile device, or other device that is operable to communicate via networks 102 and 106. The user device 110 may be used as or used to control a media type. As used herein, the term “media type” may include communication device, system, and/or service. Exemplary media types include social network service, instant messaging services, short message services, multimedia services, mobile devices, telecommunication devices, other device or service for communication, or any combination thereof. For example, in one embodiment, the user device 110 may be a personal computer that allows the user 112 to communicate using an instant messaging service.

The contact device 120 may be owned, operated, controlled, managed, or otherwise used by a contact 122. The contact 122 may be a human or electronic computing device (e.g., including a processor and/or memory) configured to control the contact device 120. The contact device 120 may be a public switched telephone, cellular telephone, personal computer, personal digital assistant, mobile device, or other device that is operable to communicate via networks 104 and 106. The contact device 120 may be used as or used to control a media type.

The user 112 may use a single user device 110 or a plurality of user devices 110, 110a, 110b. The contact 122 may use a single contact device 120 or a plurality of contact devices 120, 120a. The system 100 may intelligently use or interact with one or more the user devices 110, 110a, 110b or contact devices 120, 120a. For example, the server 130 may determine which of the user devices 110, 110a, 110b and contact devices 120, 120a to perform communication setup between.

The user 112 and contact 122 may be directly or indirectly connected. In other words, the user 112 and contact 122 may be known to each other, socially or genetically related to each other, or otherwise associated. For example, the user 112 and contact 122 may be associated (e.g., acquainted, related) through family, friends, co-workers, interest groups, acquaintances, contact lists (e.g., list of local companies or businesses), on-line social networking services (e.g., Facebook®, Linked-In®), online dating services (e.g., Match.com®), on-line phone books, other on-line services, or any combination thereof. In one example, the user 112 may meet the contact 122 at an interest group event, such as a running club, wine tasting event, business conference, or automobile show. The user 112 may enter the contact information (e.g., name, number, photo, etc.), which identifies the contact 122, into the user's contact list. In an alternative embodiment, the user 112 and/or contact 122 may not be known by each other.

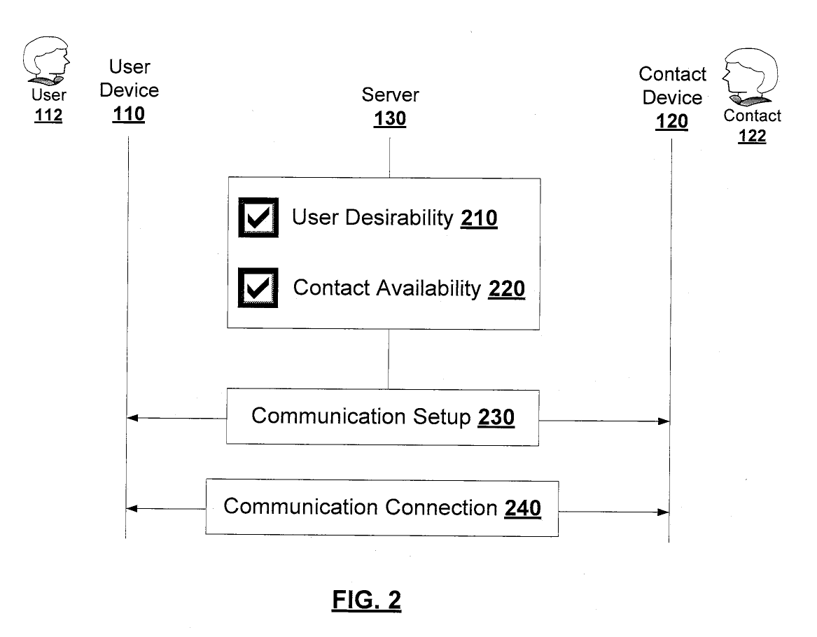

FIG. 2 illustrates one embodiment of the interaction between the components of the communication system 100 of FIG. 1. The server 130 may monitor user desire 210, contact availability 220, or both user desire 210 and contact availability 220. Monitoring may include receiving user desire 210 and/or contact availability 220 information. The information may be received directly from the user device 110 and/or contact device 120 or indirectly received via one or more intermediary components. Intermediary components may include intermediary servers, computers, or networks. For example, monitoring may include receiving user desire information from a social network server hosting an online social network service or from the user device 110.

User desire 210 includes, indicates, or represents the user's 112 desire, want, need, or willingness to communicate with the contact 122. Contact availability 220 includes, indicates, or represents the contact's ability to communicate with the user 112. As shown in FIG. 2 with the “check,” the server 130 may determine when or whether user desire 210 includes, indicates, or represents that the user 112 desires, wants, needs, or is willing to communicate with the contact 122. The server 130 may determine when contact availability 220 includes, indicates, or represents that the contact 122 is willing or has the ability to communicate with the user 112, as shown with the “check” in FIG. 2. A binary determination is shown, but three or more levels of user desire 210 and/or contact availability 220 may be provided.

The server 130 may be operable to perform communication setup 230 based on user desire 210, contact availability 220, or both user desire 210 and contact availability 220. Communication setup 230 may include setup of one or more communication connections (hereinafter, communication connection) 240 among one or more endpoints. Setup may include directly or indirectly initiating, reserving, requesting, preparing, commanding, establishing, allowing, or any combination thereof. As discussed above, the communication connection 240 may be an audio connection (e.g., phone call), textual connection (e.g., text message service or instant messaging service), graphical connection (e.g., media message service), video connection (e.g., videoconference), or any combination thereof. Examples of communication setup may include establishing a phone call, initiating a chat session, or sending a text message.

In other embodiments, communication setup 230 may include confirming whether the user 112 and/or contact 122 are available or desire for a communication connection 240 to be established between the user device 110 and contact device 120. For example, prior to placing a phone call to the contact device 120, the server 130 may send a text message that confirms that the contact 122 wants to communicate with the user 112. The contact 122 may use the contact device 120 to send a “yes” or “no” reply. In another example, the server 10 may transmit an instant message to the contact device 120 requesting confirmation before establishing an instant messaging service between the user device 110 and contact device 120.

The server 130 may perform communication setup 230 manually (e.g., with user and/or contact interaction), automatically (e.g., without user and/or contact interaction), or semi-automatically. For example, in one embodiment, as shown in FIG. 2, communication setup 230 may be performed when the user 112 desires, wants, or needs to communicate with the contact 122 and the contact 122 is available.

Once the communication connection 240 has been established, the user 112 and contact 122 may communicate via the communication connection 240 using the user device 110 and contact device 120. The communication connection 240 may be established across network 106 or other network. The communication connection 240 may be established through the server 130 or independently of the server 130.

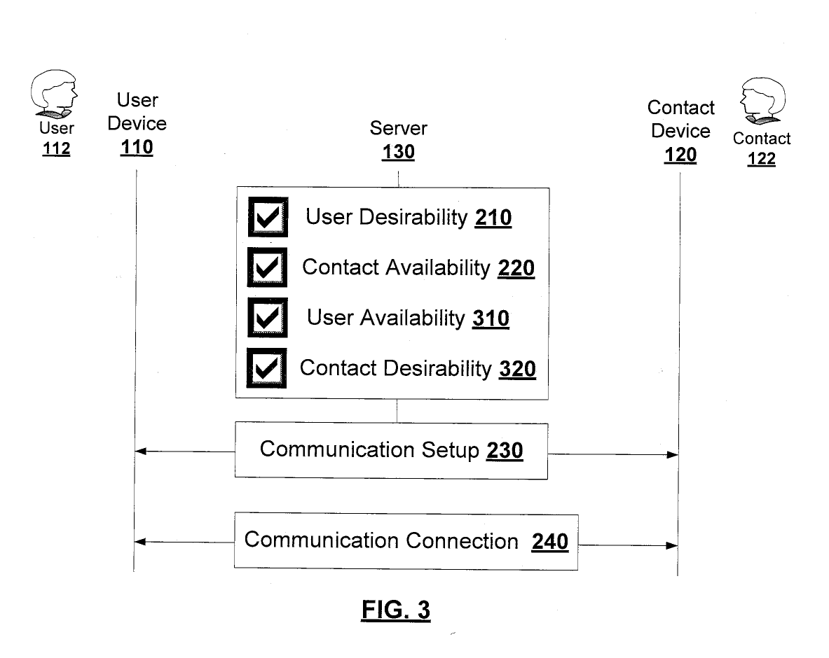

In one embodiment, as shown in FIG. 3, communication setup 230 may be based on contact desire 320. Contact desire 320 includes, indicates, or represents a contact's desire, want, or need to communicate with a user. Contact desire 320 may be used in combination with user desire 210, contact availability 220, or both user desire 210 and contact availability 220. For example, in one embodiment, even when the user 112 desires to communicate with the contact 122 and the contact 122 is available, communication setup 230 may only be performed when the contact 112 desires, wants, needs, or is willing to communicate with the user 112.

In another embodiment, communication setup may be based on user availability. User availability indicates the user's ability to communicate with the contact. User availability may be used in combination with user desire, contact availability, contact desire, or any combination thereof. For example, in one embodiment, communication setup may be performed when both the user and contact desire, want, or need to communicate with each other and both the user and contact are available.

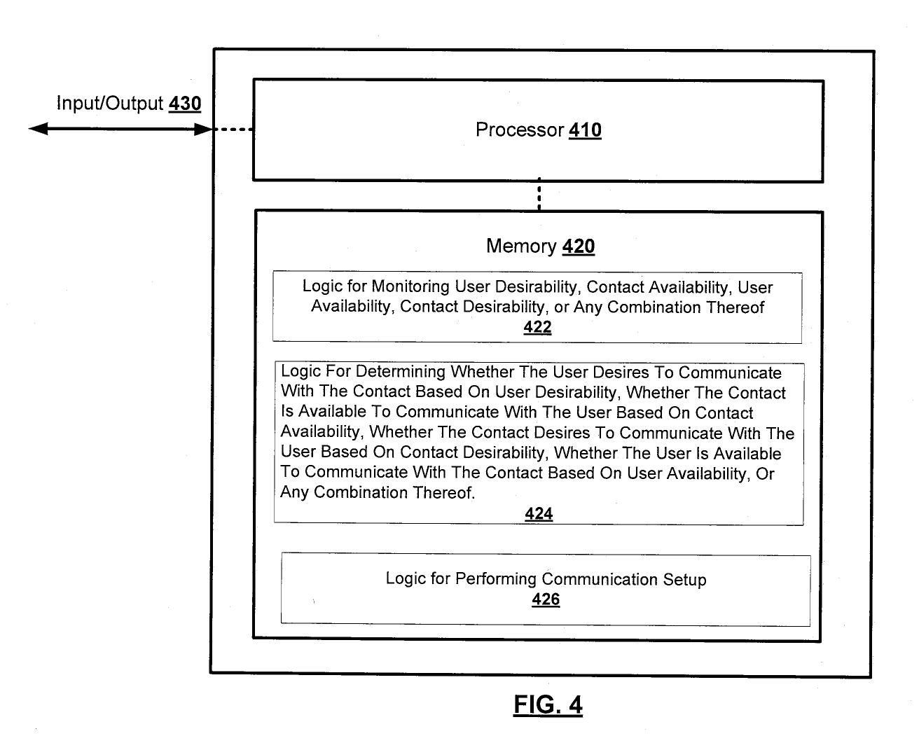

FIG. 4 illustrates one embodiment of the server 130. The server 130 may include a processor 410, memory 420, and input/output 430. Additional, different, or fewer components may be provided. The processor 410 may be coupled with the memory 420 and input/output 430. Although the server 130 is referred to herein as a server, the server 130 may be a personal computer, gateway, router, mobile device, or other networking device. In an alternative embodiment, one, some, or all of the acts performed by the server 130 may be performed on or in the user device 110 and/or contact device 120.

The processor 410 may be a general processor, digital signal processor, application specific integrated circuit, field programmable gate array, analog circuit, digital circuit, combinations thereof, or other now known or later developed processors. The processor 410 may be single device or a combination of devices, such as associated with a network or distributed processing. Any of various processing strategies may be used, such as multi-processing, multi-tasking, parallel processing, or the like. Processing may be local, as opposed to remotely. In an alternative embodiment, processing may be performed remotely. Processing may be moved from one processor to another processor. The processor 410 may be responsive to logic encoded in tangible media. The logic may be stored as part of software, hardware, integrated circuits, firmware, micro-code or the like.

The memory 420 may be computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 420 may be a single device or combinations of devices. The memory 420 may be adjacent to, part of, programmed with, networked with and/or remote from processor 410.

The processor 410 may be operable to execute logic encoded in one or more tangible media, such as memory 420. Logic encoded in one or more tangible media for execution may be instructions that are executable by the processor and that are provided on the computer-readable storage media, memories, or a combination thereof. The processor 410 is programmed with and executes the logic. The functions, acts or tasks illustrated in the figures or described herein are executed in response to one or more sets of logic or instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination.

In one embodiment, as shown in FIG. 4, the memory 420 may include logic for monitoring user desire, contact availability, user availability, contact desire, or any combination thereof 422. the processor 410 may execute the logic to monitor user desire, contact availability, user availability, contact desire, or any combination thereof.

The memory may also include logic for determining whether the user desires to communicate with the contact based on user desire, whether the contact is available to communicate with the user based on contact availability, whether the contact desires to communicate with the user based on contact desire, whether the user is available to communicate with the contact based on user availability, or any combination thereof 424.

The memory 420 may also include logic for performing communication setup 426.

The input/output 430 may include an input, output, or both an input and output. The input/output 430 may include a communication interface that is operable to transmit and/or receive information, such as user desire information, contact availability information, user availability information, contact desire information. The communication interface may be an input interface and/or an output interface. In one embodiment, the communication interface may include a communication circuit that is operable to transmit and receive information.

The input/output 430 may include additional, different, or fewer components. For example, in one embodiment, the input/output 430 includes a wireless transmission device that is operable to wirelessly transmit and/or receive information via the communication interface. In another embodiment, the input/output 430 may include an electronic display device, controller, other device for interacting with the user device 110, contact device 120, or a combination thereof. The electronic display device may be a cathode ray tube (CRT), monitor, flat panel, a general display, LCD, projector, printer or other now known or later developed display device for outputting information. The electronic display device may display one or more images, such as text, video, pictures, or other data. The controller may be a keyboard, mouse, trackball, or touch screen.

All or some of the communication system 100 may be used in combination with online services. Online services may include services or products that are received, delivered, provided, initiated, ordered, or otherwise controlled via a local or global computer network, such as the Internet. Exemplary online services include social networks (e.g., Facebook®, LinkedIn®, Twitter®, and eHarmony.com®) and search engines (e.g., Google® or Bing®). The communication system 100 may be used in combination with other services, such as other online services or offline services.

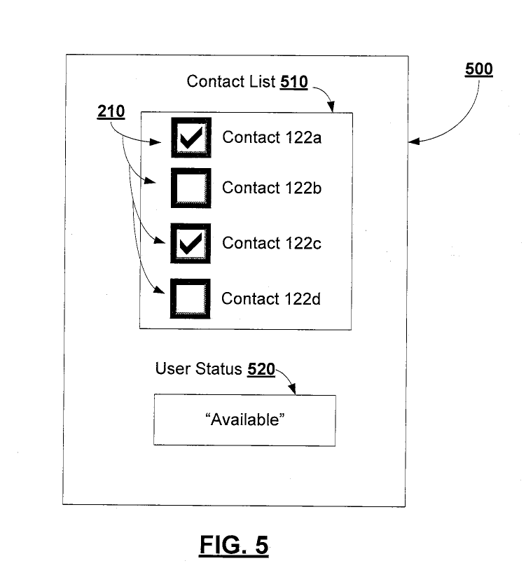

FIG. 5 illustrates one example of using the communication system 100 in combination with a social network service 500. The social network service 500 may be used to build an online community of people who share interests and/or activities, or who are interested in exploring the interests and activities of others. The social network service 500 may be Web based and may provide one or a variety of ways for users to interact with contacts, such as e-mail and instant messaging services.

The social network service 500 may include a contact list 510, a user status 520, or both a contact list 510 and user status 520. The contact list 510 may be a phone list, instant messaging list, collection of names or numbers representing contacts 122, or any combination thereof. For example, the contact list may be a collection of screen names in an instant messaging or e-mail program or online game or mobile phone. The contact list may have various trademarked and proprietary names in different contexts or media. The style of the contact list is different with the different programs.

The contact list 510 may include one or more contacts 122 from all, some, or none of the user's community, acquaintances, friends, family, social network, business network, or combination thereof. The user 112 may select all, some, or none of the contact list 510. Selection may include moving, highlighting, marking, or otherwise indicating selection. In one embodiment, the user 112 may select one or more contacts 122 that the user wants, needs, or desires to communicate with. For example, in one embodiment, as shown in FIG. 5, the user 112 may select contact 122a and contact 122c but not contact 122b and contact 122d. In FIG. 5, the user 112 selected contact 122a and contact 122c are indicated by marking their names with a checkmark. In an alternative embodiment, the user 112 may select all the contacts 122a-d. The selection of contacts 122 in a contact list 510 may be used by the server 130 to determine user desire 210. In other words, selection of one or more contacts 122 may indicate that the user 112 wants, needs, or desires to communicate with the selected contacts. For example, the user 112 may indicate that the user 112 does not want, need, or desire to communicate with a contact 122 by not selecting the contact 122 in the contact list 510. In an alternative embodiment, selection of others may indicate that the user 112 does not want, need, or desire to communicate with a contact 122 by not selecting the contact 122 in the contact list 510.

Accordingly, the server 130 may monitor user desire 210 based on the contact list 510. Monitoring may include receiving contact list information, such as information about selection of a contact 122 from a contact list 510, from a social network server hosting the social network service 500. The server 130 may request the contact list information from the social network server. In an alternative embodiment, the server 130 may register with the social network server to receive contact list information continuously or periodically, for example, each time a contact 122 is selected or unselected.

In FIG. 5, the user status 520 may indicate user availability 310. The user may update, change, edit, define, or select the user status 520. For example, the user may change the user status 520 to “available,” “busy,” “bored,” “at work,” “traveling,” or another predefined or user customized status. The server 130 may monitor the user status 520 in order to determine user availability 310. In one embodiment, when the user status 520 is “available” or “bored,” the server 130 may determine that the user 112 is available. However, when the user status 520 is “busy,” “at work,” or “traveling,” the server 130 may determine that the user 112 is not available. The user status 520 may be a status in Facebook,® Twitter® or other social network.

The server 130 may monitor user availability 310 based on the user status 520. Monitoring may include receiving user status information, such as information about the user status 520, from a social network server hosting the social network service 500. The server 130 may request the user status information from the social network server. In an alternative embodiment, the server 130 may register with the social network server to receive contact list information continuously or periodically, for example, each time the user status 520 is changed.

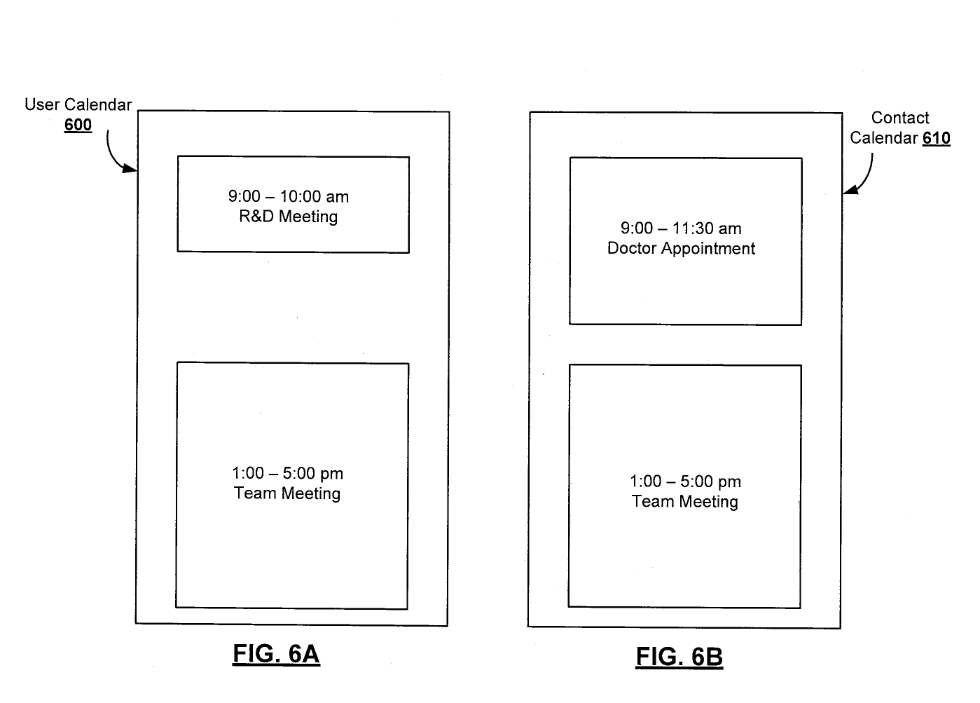

FIG. 6 illustrates a user calendar 600 for user 112 and a contact calendar 610 for contact 122. The calendars 600, 610 may be used to determine user availability 310 and/or contact availability 220. The calendars 600, 610 may be electronic calendars, such as calendars in Microsoft Outlook®. The calendars 600, 610 shown in FIG. 6 are daily calendars. However, the calendars 600, 610 may be hourly calendars, weekly calendars, monthly calendars, or yearly calendars. The calendars 600, 610 may be used to schedule, record, or monitor calendar events for any length of time.

In the event that the user 112 wants, needs, or desires to communicate with contact 122, the server 130 may perform communication setup when the contact 122 becomes available. In other words, the server 130 may monitor the contact calendar 610 and determine when the contact 122 is available (e.g., does not have other meetings scheduled). In FIG. 6, the contact 122 is available from 11:30 am-1:00 pm during the business day. Accordingly, the server 130 may perform communication setup at 11:45 am.

In one embodiment, the server 130 may perform communication setup based on zero, one, or more scheduling policies defined for the user 112 and/or contact 122. For example, the server 130 may only perform communication setup during business hours (e.g., 8:00 am-5:00 pm). In another example, the server 130 may only perform communication setup after waiting for a predefined amount of time (e.g., 15 minutes) after the last scheduled meeting. This will allow the contact 122 to finish the meeting.

In one embodiment, the server 130 may send a request message to the contact 122 prior to performing communication setup. The request message may be used to accept, deny, or change communication with the user 112. For example, the request message may indicate: “User 112 desires to communicate with you, are you willing to be connected to user 112 at 10:00 am?” The contact 122 may accept, for example, by selecting a confirmation button or generating a message. In one embodiment, the response message may be customized, for example, changing the time to perform communication setup. For example, the contact 122 may send a response message to the server 130 indicating: “schedule for 11 am.” In other words, the contact 122 may request that communication setup be performed at 11:00 am.

The request message may be transmitted to the contact 112 on the same or different media (e.g., audio, text, graphic, video) as the communication connection. For example, if the communication connection is audio (e.g., a phone call), the request message may be transmitted to the contact 122 via a text message.

The user 112 may receive a copy of the request and/or response message. However, the request message may be used to protect the contact's privacy. Accordingly, the user 112 may not receive a copy or any indication that the server 130 is attempting to schedule communication setup with the contact 122.

In one embodiment, communication setup may be performed based on user desire, user availability, and contact availability. For example, once the server 130 determines that the user 112 wants, needs, or desires to communicate with the contact 122, the server 130 may compare calendars 600, 610 to determine a mutually convenient time to perform communication setup. For example, the server 130 may determine that both the user 112 and contact are available at 11:30 am and perform communication setup at that time.

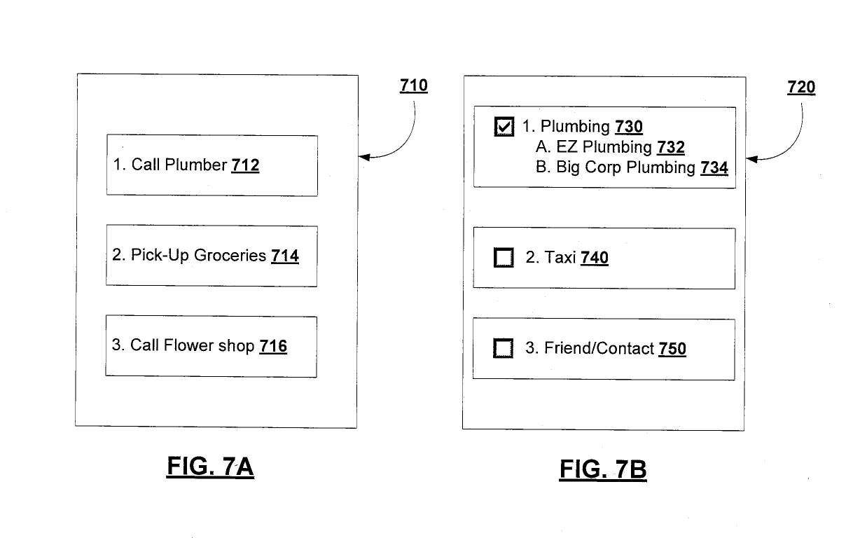

FIG. 7A illustrates one embodiment of using the system 100 with a user's task list 710. The task list 710 may be a web-based list and/or electronic task list. The task list 710 may be referred to as a to-do list. The task list 710 may include zero, one, or more tasks 712-714 to be completed by the user 112. For example, the task list 710 may be a list of tasks to be completed, such as chores or acts toward completing a project. The task list 600 may be used as an inventory tool used in self-management, grocery lists, business management, project management, and software development. The task list 710 may involve more than one list. For example, the task list 710 may combine a grocery list and a business management list.

The server 130 may monitor the task list 710 and perform communication setup based on the task list 710. For example, the server 130 may determine that the user 112 wants, needs, or desires to call the plumber based on task 712. The task list 710 may be used to determine user desire. The server 130 may automatically search for a plumber, for example, in the user's contact list 510 shown in FIG. 5, an electronic phone book, or on the Internet. Alternatively, the task 712 may include a phone number for the plumber.

FIG. 7B illustrates one embodiment of using the system 100 with a matching application 720, such as a computer application, mobile device application, or networking application. For example, in one embodiment, the application 720 is a cellular telephone application that is executed on a cellular telephone. The application 720 may allow a user to select a contact 122, which may be a service, company, person, or other contact. As shown in FIG. 7B, the user 112 may select a service 730. Based on the service 730, which was selected, a company 732, 734 may be selected, for example, by searching a phone list and applying zero, one, or more criterion. The criterion may include time, location, or needs of the user 110 and/or contact 122. For example, in one embodiment, the criterion may be the user's location, for example, determined using a global positioning device in the user device 110. A company 732, 734 may be selected that is closest in physical location to the user 112. In another example, the user 112 may select a taxi service 740. The application 720 may be used to initiate communication setup with a taxi service. In another example, the user 112 may select a friend/contact 750 in the application 720 and communication setup may be performed between the user 112 and the friend/contact 750.

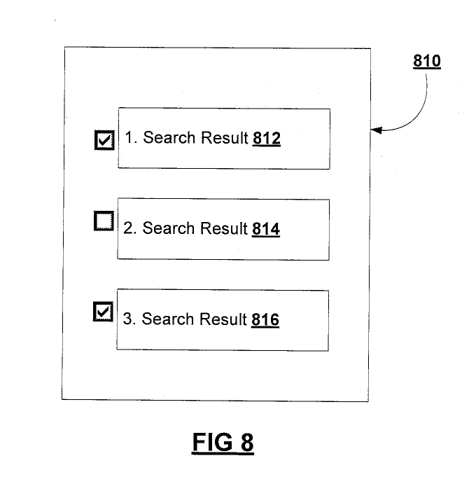

FIG. 8 illustrates one embodiment of using the system 100 with a search engine 810. The search engine 810 may be used to return one or more search results 812, 814, 816. The user may select one or more of the search results 812, 816. The selected search results may be used to indicate user desire. For example, the search result 812 may be a contact number. The contact number may be associated with a store, which has store hours, which may indicate the contact availability. The user desire and contact availability may be used to determine when to perform communication setup.

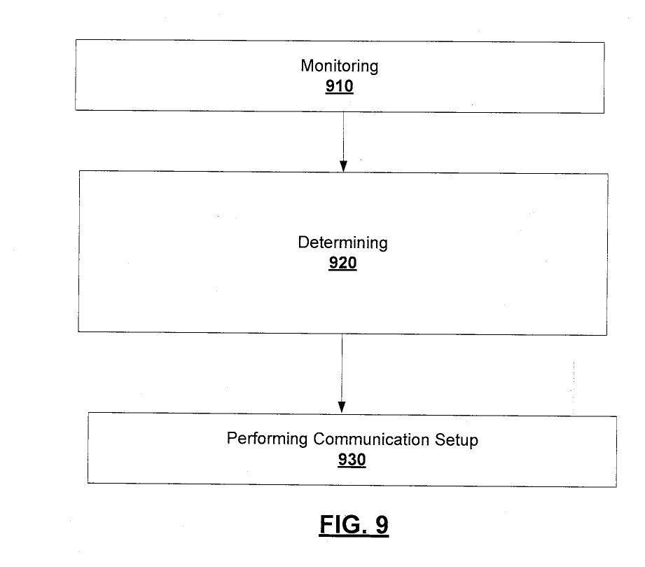

FIG. 9 illustrates one embodiment of a method 900 for performing communication setup. The method may be performed by one, some, all, or a combination of the components in the system 100 of FIG. 1. The method 900 may include monitoring 910, determining 920, and performing communication setup 930.

In act 910, a server may monitor user desire, contact availability, user availability, contact desire, or any combination thereof. Monitoring may include receiving data, such as user desire data, contact availability data, user availability data, contact desire data, from a user device and/or contact device. The data may be received from other devices, such as data collection devices, data aggregation devices, or other networking devices. For example, the data may be received from a server that hosts a social network service, task list, service list, search engine, or other application. Monitoring may include requesting the data. For example, the server may request user desire data from a user device. In an alternative embodiment, the data may be transmitted to the server without a request.

In act 920, the server may determine whether the user wants, needs, or desires to communicate with the contact based on user desire, whether the contact is available to communicate with the user based on contact availability, whether the contact wants, needs, or desires to communicate with the user based on contact desire, whether the user is available to communicate with the contact based on user availability, or any combination thereof.

In act 930, the server may perform communication setup based on user desire, contact availability, contact desire, user availability, or any combination thereof. Performing communication setup may include setting up a communication connection between a user and a contact.

Various embodiments described herein can be used alone or in combination with one another. The foregoing detailed description has described only a few of the many possible implementations. For this reason, this detailed description is intended by way of illustration, and not by way of limitation. Equivalents of one, some, or all of the components or acts described herein are intended to be included in the scope of the present embodiments.

1. A method comprising:
monitoring user desire for a user and contact availability for a contact, wherein user desire indicates whether the user desires to communicate with the contact and contact availability indicates whether the contact is available to communicate with the user;
determining whether the user desires to communicate with the contact based on user desire and whether the contact is available to communicate with the user based on contact availability; and
performing communication setup when the user desires to communicate with the contact and whether the contact is available to communicate with the user.

2. The method of claim 1, wherein monitoring includes receiving user desire information and contact availability information, the user desire information defines whether the user desires to communicate with the contact and the contact availability information defines whether the contact availability indicates whether the contact is available to communicate with the user.

3. The method of claim 1, wherein performing communication setup includes setting up a communication connection between a user device and a contact device.

4. The method of claim 3, wherein performing communication setup includes sending a confirmation request to the contact prior to setting up the communication connection, the confirmation request confirming that the contact approves of a communication connection between the user and the contact.

5. The method of claim 1, further comprising:
monitoring contact desire, wherein contact desire indicates the contact's want, need, or desire to communicate with the user;
determining whether the contact wants, needs, or desires to communicate with the user based on the contact desire; and
performing communication setup when the contact wants, needs, or desires to communicate with the user based on the contact desire.

6. The method of claim 1, further comprising:
monitoring user availability, wherein user availability indicates the user's availability to communicate with the contact;
determining whether the user is available to communicate with the contact based on the user availability; and
performing communication setup when the user is available to communicate with the contact.

7. The method of claim 1, wherein monitoring includes receiving user desire information from a server hosting a social networking service.

8. A networking device comprising a processor operable to:
monitor user desire for a user and contact availability for a contact, wherein user desire indicates whether the user desires to communicate with the contact and contact availability indicates whether the contact is available to communicate with the user;
determine whether the user desires to communicate with the contact based on user desire and whether the contact is available to communicate with the user based on contact availability; and
perform communication setup when the user desires to communicate with the contact and whether the contact is available to communicate with the user.

9. The network device of claim 8, wherein the processor is operable to receive user desire information and contact availability information, the user desire information defines whether the user desires to communicate with the contact and the contact availability information defines whether the contact availability indicates whether the contact is available to communicate with the user.

10. The network device of claim 8, wherein the processor is operable to set up a communication connection between a user device and a contact device.

11. The network device of claim 8, wherein the processor is operable to send a confirmation request to the contact prior to setting up the communication connection, the confirmation request confirming that the contact approves of a communication connection between the user and the contact.

12. The network device of claim 8, the processor is operable to:
monitor contact desire, wherein contact desire indicates the contact's want, need, or desire to communicate with the user;
determine whether the contact wants, needs, or desires to communicate with the user based on the contact desire; and
perform communication setup when the contact wants, needs, or desires to communicate with the user based on the contact desire.

13. The network device of claim 8, the processor is operable to:
monitor user availability, wherein user availability indicates the user's availability to communicate with the contact;
determine whether the user is available to communicate with the contact based on the user availability; and
perform communication setup when the user is available to communicate with the contact.

14. The network device of claim 8, wherein the processor is operable to receive user desire information from a server hosting a social network service.

15. A method comprising:
receiving, using a processor, an indication that a user wants, needs, or desires to communicate with a contact;
receiving an availability of the contact; and
performing, using the processor, communication setup between a user device and a contact device when the contact is selected and is available.

16. The method of claim 15, wherein the indication is a selection of the contact from a contact list.

17. The method of claim 15, wherein performing communication setup includes establishing a communication connection.

18. The method of claim 17, wherein the communication connection is a telephone connection.

19. The method of claim 18, wherein the telephone connection is established without interaction from the user or contact.

20. The method of claim 15, wherein the telephone connection is established with at least some interaction from the user or contact.
